(19) United States
(12) Patent Application Publication
(10) Pub. No.: US 2019/0362457 A1
(43) Pub. Date: Nov. 28, 2019

(54) SMART PARKING LOCATOR AND RESERVATION SYSTEMS

(71) Applicant: Amol Mozarkar, Etobicoke (CA)

(72) Inventor: Amol Mozarkar, Etobicoke (CA)

(21) Appl. No.: 16/418,974

(22) Filed: May 21, 2019

Related U.S. Application Data
(60) Provisional application No. 62/675,330, filed on May 23, 2018.

(51) Int. Cl. G06Q 50/30; G06Q 20/40; G06Q 20/14

(52) U.S. Cl. CPC G06Q 50/30; G06Q 2220/00; G06Q 20/145; G06Q 20/401

(57) ABSTRACT

The parking locator and reservation system is an electronic communication-based system that utilizes block chain and crypto currency payments for parking spot locating, reservation, payment and available parking posting. The system may be easily integrated into a variety of vehicle styles and models. The system utilizes hardware including sensors, IoT gateways, switches, routers, and hubs and software including mobile applications, web applications, console readers, barcode scanners, GPS trackers and google navigational APIs.

### REFERENCE TO PENDING APPLICATIONS

This application claims the benefit of U.S. Provisional Patent Application Ser. No. 62/675,330, entitled SMART PARKING LOCATOR AND RESERVATION SYSTEMS filed on May 23, 2018.

### BACKGROUND OF THE INVENTION

### 1. Field of the Invention

The present invention relates generally to the field of electronic communications and more specifically relates to parking locator and reservation systems.

### 2. Description of the Related Art

There is an ongoing increase in the number of vehicles on the road that need to find parking. At large events (airports and work places in particular) parking is continuing to be less available and harder to find. Web-based parking locator and reservation systems are utilized by drivers to locate parking spots near them or at specific destinations, check for types of parking and the purchase or reservation of parking spots. The systems may allow users to see how many spots are available at a specific location as well as attaining an estimate of the cost to park for a desired length of time. Some systems may allow access by event management or traffic control engineers to get advanced data on expected traffic and the resulting traffic congestion at events or during rush-hour travel. Many of the systems also include a system to identify vehicles and drivers associated with the system or user.

There are numerous systems and methods to find and purchase available vehicle parking. For example, some iterations of parking systems allow users access to a webpage to purchase a parking pass and acquire a GPS route to the parking facility. In other iterations, users are able to download an application to an electronic communication device to acquire the desired information and purchase parking. Still other systems may alert drivers to traffic condition when considering which available location to park at. However, the payment plans of current systems are constrained to the limitations of the parking application and normally require users to pick a pre-paid, credit or token-based payment plan. They do not incorporate a system that allows above mentioned payments as well as cryptocurrencies and block chain transactions payments from the application to pay for and reserve a parking spot. Also, current systems only allow for the purchase of parking spots. They do not incorporate the ability to list available parking spots on web-based apps, such as Airbnb. A suitable solution is desired.

Various attempts have been made to solve problems found in parking locator and reservation art. Among these are found in: Patent and Publication Nos. CA 2,573,766 to Halleran; 2014/0372155 to Wang; and U.S. Pat. No. 8,671,002 to Stefik; 2013/0346121 to Shealy. This prior art is representative of parking locator and reservation systems.

None of the above inventions and patents, taken either singly or in combination, is seen to describe the invention as claimed. Thus, a need exists for a reliable parking locator and reservation system, and to avoid the above-mentioned problems.

### BRIEF SUMMARY OF THE INVENTION

In view of the disadvantages inherent in the known art, the present invention provides a novel parking locator and reservation system, which may also be referred to as the “Smart Parking Locator and Reservation system.” The present invention is superior to other systems in that it effectively incorporates parking spot location and reservation service utilizing block chain and crypto currency payments. Further, the invention allows users to list available parking locations on the reservation platform and to be easily integrated into a variety of vehicle styles and models by anyone skilled in the art of vehicle accessory installation.

The parking spot locator and reservation system may include hardware network integration that incorporates sensors, IoT gateways, switches, routers and hubs. The system's integrated software networks may include mobile applications, web applications, console readers, barcode scanners, GPS trackers and google navigational APIs. The system may use a chain-based payment system that works on Etheirum based ERC20 technology or a system of crypto based currency. The system may further include methods for the locating, reserving, modification and payment for parking spots as well as listing of available parking.

Further, the parking spot locator and reservation system may give users real time notification about the traffic situations to the reserved parking locations and make suggestions to an alternative parking spot with less traffic congestion. This may solve the many traffic issues in the urban cities.

The parking spot locator and reservation system may also allow users to find and reserve a parking spot anytime anywhere from their telecommunication device, internet facing web consoles and computer operated and desktop applications.

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

The figure which accompany the written portion of this specification illustrate the embodiments and method(s) of use for the present invention, parking locator and reservation system, constructed and operative according to the teachings of the present invention.

FIG. 1 is a schematic block diagram of a system in accordance with embodiments of the present invention.

FIG. 2 is a block diagram of a data processing system implementing a parking locator and reservation system server in accordance with embodiments of the present invention.

FIG. 3 is a detailed block diagram of a data processing system implementing a parking locator and reservation system server in accordance with embodiments of the present invention.

FIG. 4 is flowchart illustrating operations for matching a user with a parking spot in accordance with embodiments of the present invention.

FIG. 5 is a flow diagram of a parking locator and reservation system showing the system steps to book parking, according to an embodiment of the present invention.

FIG. 6 is a flow diagram of a parking locator and reservation system showing the steps to manage bookings, according to an embodiment of the present invention.

FIG. 7 is a flow diagram of a parking locator and reservation system showing the operational steps of the invention, according to an embodiment of the present invention.

FIG. 8 is a flow diagram of a parking locator and reservation system showing the steps to find available parking spots, according to an embodiment of the present invention.

FIG. 9 is a flow diagram of a parking locator and reservation system showing the steps to reserve or release a parking spot, according to an embodiment of the present invention.

The various embodiments of the present invention will hereinafter be described in conjunction with the appended drawings, wherein like designations denote like elements.

### DETAILED DESCRIPTION

The present invention is directed to an electronic communication based system that may be used to locate, reserve and pay for parking utilizing block chain or crypto payment systems. The system also allows users to register their open parking spots on networks and these spots will become available for the discovery and reservation over mobile apps and web consoles, such as Airbnb. This will help reduce the scarcity of parking locations in the city.

As used herein, the term “parking facility” is broadly used to define any open parking spots that are available for use, including but not limited to an individual seeking rent out a single open parking spot in a privately owned garage to a corporate entity owing multiple parking lots with multiple parking spots.

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by one of skill in the art, the present invention may be embodied as a method, data processing system, and/or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer usable storage medium having computer-usable program code means embodied in the medium. Any suitable computer readable medium may be used including hard disks, CD-ROMs, optical storage devices, a transmission media such as those supporting the Internet or an intranet, or magnetic storage devices.

Computer program code for carrying out operations of the present invention may be written in an object oriented programming language, such as Java® or C++. However, the computer program code for carrying out operations of the present invention may also be written in conventional procedural programming languages, such as the “C” programming language or assembly language. The program code may execute entirely on the user's computer, partly on the user's computer, as a stand alone software package, partly on the user's computer and partly on a remote computer, or entirely on the remote computer. In the latter scenario, the remote computer may be connected to the user's computer through a local area network (LAN) or a wide area network (WAN).

The present invention is described below with reference to flowchart illustrations and/or block diagrams of methods, apparatus (systems) and computer program products according to some embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks.

These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified in the flowchart and/or block diagram block or blocks.

Embodiments of the present invention will now be described with respect to the figures. Embodiments of the present invention provide methods, systems and/or computer program products for a novel parking locator and reservation system.

In one embodiment of the present invention, the parking locator and reservation system may compromise hardware utilization of sensors, IoT gateways, switches, routers, and hubs to facilitate the communication between software applications at both the home user and provider locations. Further, the software networks may utilize electronic communication programs including but not limited to mobile applications, web applications, console readers, barcode scanners, GPS trackers and google navigational APIs. Software may include a payment transaction network which utilizes a block-chain based system that works on Etheirum based ERC20 technology as well as an alternative crypto currency-based method of payment.

In another embodiment, the invention would assign users a Universal Identification number (UIN). This would work across borders and geographic to make reservations using the platform. This may avoid the need to print any parking tickets which may help save environment and paper wastage. This embodiment would also show users the available parking locations around them or their destination location and also show then how many spots are empty/available at each of those locations.

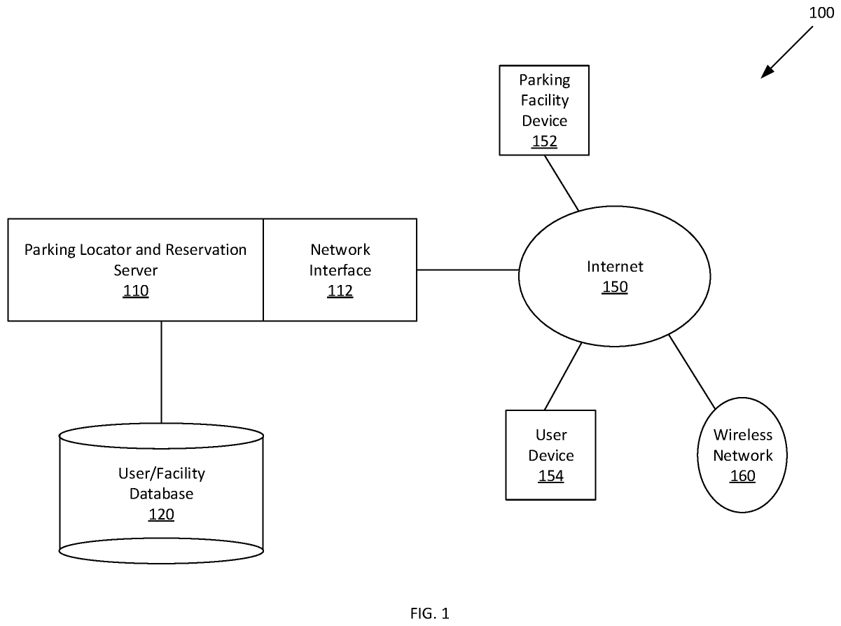

Referring first to FIG. 1, a hardware and software environment including embodiments of the present invention will be described. As shown in FIG. 1, a parking locator and reservation system server 110 is coupled through a network interface 112 to a network 150, such as an internet network. The parking locator and reservation system server 110 is further operatively coupled to a user/facility database 120. The parking locator and reservation system server 110 is configured to identify a parking spot as requested by a user based on various criteria of the consumer, including location, date, cost and duration of availability. The user/facility database 120 contains information related to users, parking facilities or both. The user/facility database 120 may contain additional information in various embodiments of the present invention, such as number of total parking spot at a parking facility, availability information for the parking spots at a parking facility, biographical information of a user, and individual preferences of a user. Thus, a parking locator and reservation system server 110 may be configured to identify a candidate parking spot based on a variety of information including, but not limited to, the location of the parking spot, the cost of the parking spot, and the date and time availability of the parking spot.

The network interface 112, as shown in FIG. 1, couples to the internet 110. The network interface 112 further couples through the internet 150 to the wireless network 160 and other devices accessible over the internet 150. However, it is to be understood that the network interface 112 may, instead, directly couple to the wireless network 160 or to other of the server and terminal devices shown as accessed over the internet 110.

The network interface 112 is further configured to receive parking spot availability information from one or more parking facility device 152 and to receive a request from a user device 154 to locate a parking spot and to provide the availability and reservation information to the parking facility devices 152 and user device 154. Network interface 112 is configured to provided received parking spot availability information and parking spot requests to the parking locator and reservation server 110. The parking locator and reservation server 110 is configured to process and match the parking spot request to one or more available parking spots based on the parking spot availability information.

Parking facility device 152 and user device 154 may each be any type of device capable of receiving and transmitting data. Examples of these devices may include a mobile device, such as a cell phone, a laptop computer, a desk-based computer and a tablet-style computer.

As will be understood by those having skill in the art, a network 150 may include a plurality of separate linked physical communication networks, which, using a protocol, such as the Internet protocol (IP), may appear to be a single seamless communications network to user application programs. In addition, the network interface 112 may be a plurality of different interfaces coupled to different network types including wired and wireless networks.

The parking facility device 152 and the user device 154 may be also be directly coupled to the parking locator and reservation system server 110 rather than connected thereto over the internet 150. Similarly, the user/facility database 120 may be accessed by the parking locator and reservation system server 110 over the internet 150 rather than being directly connected to the parking locator and reservation system server 110.

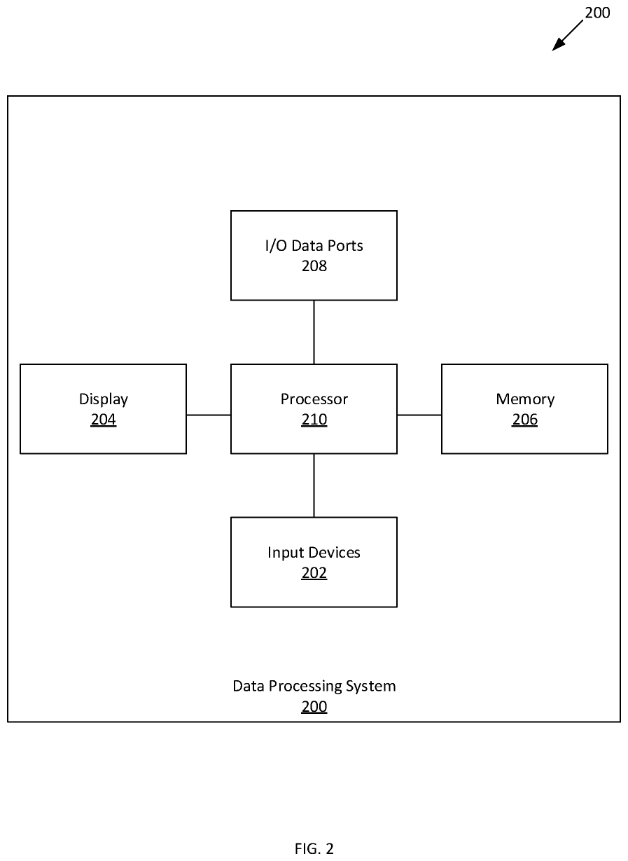

FIG. 2 illustrates an exemplary embodiment of a data processing system 200 suitable for use in accordance with embodiments of the present invention. The data processing system 200 typically includes input device(s) 202 such as a keyboard or keypad, a display 204, and a memory 206 that communicate with a processor 210. The data processing system 200 may further include an I/O data port(s) 208 that also communicate with the processor 210. The I/O data ports 208 can be used to transfer information between the data processing system 200 and another computer system or a network, such as the network 150 of FIG. 1. These components may be conventional components, such as those used in many conventional data processing systems, which may be configured to operate as described herein

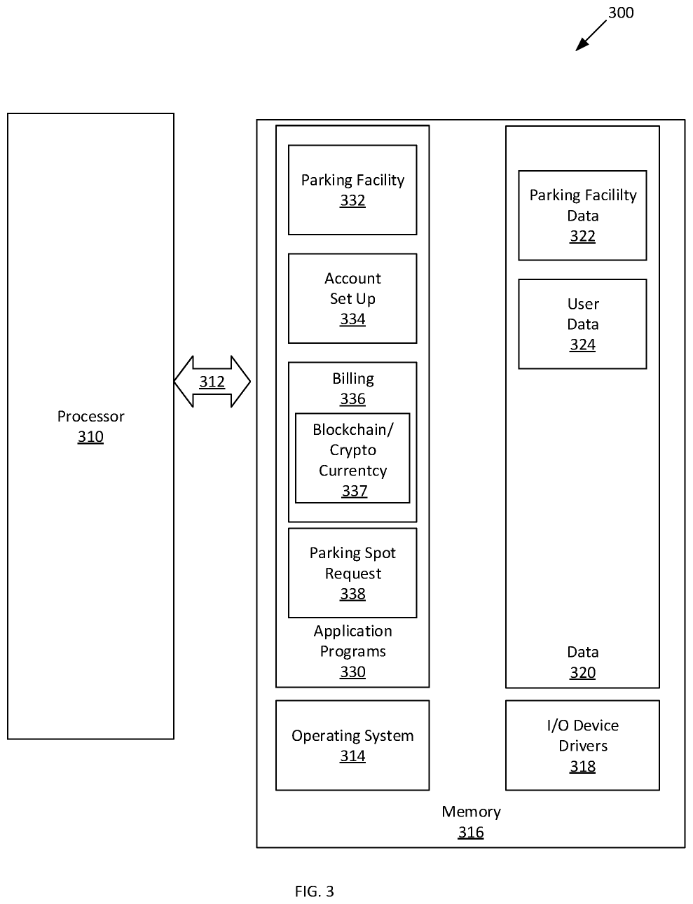

FIG. 3 is a block diagram of a data processing (computer) system that further illustrates systems, methods, and computer program products in accordance with embodiments of the present invention. The processor 310 communicates with the memory 316 via an address/data bus 312. The processor 310 can be any commercially available or custom microprocessor. The memory 316 is representative of the overall hierarchy of memory devices containing the software and data used to implement the functionality of the data processing system 300. The memory 316 can include, but is not limited to, the following types of devices: cache, ROM, PROM, EPROM, EEPROM, flash memory, SRAM, and DRAM.

As shown in FIG. 3, the memory 316 may include several categories of software and data used in the data processing system 300: the operating system 314; the application programs 330; the input/output (I/O) device drivers 318; and the data 320. As will be appreciated by those of skill in the art, the operating system 314 may be any operating system suitable for use with a data processing system, such as Solaris from Sun Microsystems, OS/2, AIX or System390 from International Business Machines Corporation, Armonk, N.Y., Windows95, Windows98, Windows NT, Windows ME, Windows XP or Windows 2000 from Microsoft Corporation, Redmond, Wash., Unix or Linux. The I/O device drivers 318 typically include software routines accessed through the operating system 314 by the application programs 230 to communicate with devices such as the I/O data port(s) 318 and certain memory 316 components. The application programs 330 are illustrative of the programs that implement the various features of the data processing system 300 and preferably include at least one application that supports operations according to embodiments of the present invention. Finally, the data 320 represents the static and dynamic data used by the application programs 330, the operating system 314, the I/O device drivers 318, and other software programs that may reside in the memory 316.

As is further seen in FIG. 3, the application programs 330 may include a parking facility module 332, an account set up module 334, a billing module 336 and a parking spot request module 338. The account set up module is configured to create accounts for parking facilities and users. An account associated with a parking facility can include various parking facility data 322 about a parking facility including but not limited to the parking facility's name, address, total number of available parking spots, and associated costs for parking. An account associated with a user may include user data 324 including but not limited to user's name, address and price preferences.

The parking facility module 332 is configured to identify one or more parking spots as candidate parking spot based on, for example, the location of the parking spot, the availability of the parking spots, the costs associated with parking at the parking spots, the type of facilities, such as being an open parking lot or a covered parking deck, and any additional services such as a car washing or detailing services.

The parking spot request module 338 is configured to receive a parking spot request from a user. A parking spot request may specify various criteria for the parking spot. The criteria may include, but not limited to, the date and time for the parking spot, the cost for the parking spot, the type of parking lot, and other additional services. Parking spot request module 338 may be configured to receive such a request specific for a parking spot and/or as an initial account set up procedure for users in the user/facility database 120. Such initial registration information may include information, such as a selection of a preferred particular type of parking facility, to be considered as a default criteria for the user in subsequent parking spot requests.

Various embodiments of the present invention further include a billing module 336 that is configured transfer payment amounts from an account of a user to an account of the parking facility for the use of a particular parking spot. Billing module 336 includes a Blockchain/crypto currently module 337 to allow for payments utilizing a digital payment technology, including block chain and/or crypto currency payment technology, along with FIAT payment systems. The use of the digital payment technology allows for enhanced traceability of the financial aspects of the transaction between the user and the parking facility. Further, blockchain and crypto currencies remove the need to convert or carry foreign currency with travelling in different countries. Examples of the blockchain technologies may include ERC20, IOTA, ETN, TRON, EOS, Monero, Hyperledger or other blockchain technologies.

The data portion 320 of memory 316, as shown in the embodiments of FIG. 3, may include various types of data, such as the parking facility data 322 and user data 324. The parking facility data 322 and user data 324, as discussed above, may include information received from the account set up module 324. Similarly, the parking facility data 322 and user data 324 may include separate accounts associated with each of the users and parking facilities and may be used by the billing module 336 in arranging payment for different parking spots.

While the present invention is illustrated, for example, with reference to the parking facility module 332 being an application program in FIG. 3, as will be appreciated by those of skill in the art, other configurations may also be utilized while still benefiting from the teachings of the present invention. For example, the parking facility module 332 may also be incorporated into the operating system 314 or other such logical division of the data processing system 200. Thus, the present invention should not be construed as limited to the configuration of FIG. 3 but is intended to encompass any configuration capable of carrying out the operations described herein.

Furthermore, while each of the parking facility module 332, an account set up module 334, a billing module 336 and a parking spot request module 338 are illustrated in a single data processing system, as will be appreciated by those of skill in the art, such functionality may be distributed across one or more data processing systems. For example, the functionality of the parking facility module 332 may be provided on one or more data processing (computer) systems that are separate from the data processing system that provides the functionality of the account setup module 334. Thus, the present invention should not be construed as limited to the configuration illustrated in FIGS. 2-3, and may be provided by other arrangements and/or division of function between data processing systems.

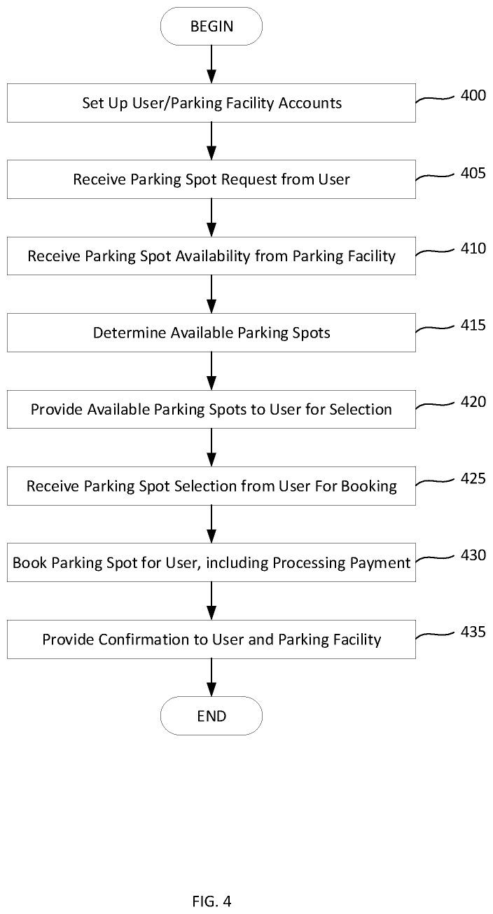

Further embodiments of the present invention are illustrated in the flow chart diagram of FIG. 4. As shown in FIG. 4, for some such embodiments, operations begin at Block 400 by account creation of a variety of users and parking facilities in the parking locator and reservation system.

A parking spot request is received from a user (Block 405). As discussed above, the parking spot request may be provided in the request received at Block 405 or may be retrieved from initial account set up information provided at Block 400. Parking spot availability is received from a parking facility at Block 410. The parking spot availability information may be received before, after or as part of the parking spot availability determination discussed below.

At Block 415, the parking spot request (Block 405) is processed by the parking locator and reservation system in order to determine the available parking spots, based on the received parking spot availability information (Block 410) that meet the parking spot request.

Upon the determination of the available parking spots, the available parking spots are provided to user at Block 420. The user is then able to review the available parking spots and select the desired parking spot.

At Block 425, the selected parking spot is received from the user and is booked, which includes processing payment for the parking spot (Block 430). Confirmation of the booked parking spot is provided to the user and parking facility (Block 435). Confirmation may be through one or more communication channels, including email and/or text message.

In some additional embodiments, a parking request is sent from the home user's parking locator and reservation system software to a parking provider's locator and reservation system software via software installed on an electronic communication system.

The software request utilizes system hardware that may include sensors, IoT gateways, switches, routers and hubs. Information sent may include, but is not limited to, current vehicle location; vehicle type; driver information; system barcode and GPS information; navigation and destination information. The system hardware may then relay information to parking facility parking locator and reservation software. Facility software accepts reservation/modification and validates chain based or crypto payment option. Hardware then relays information via software to home user's electronic communication system utilizing the parking locator and reservation system.

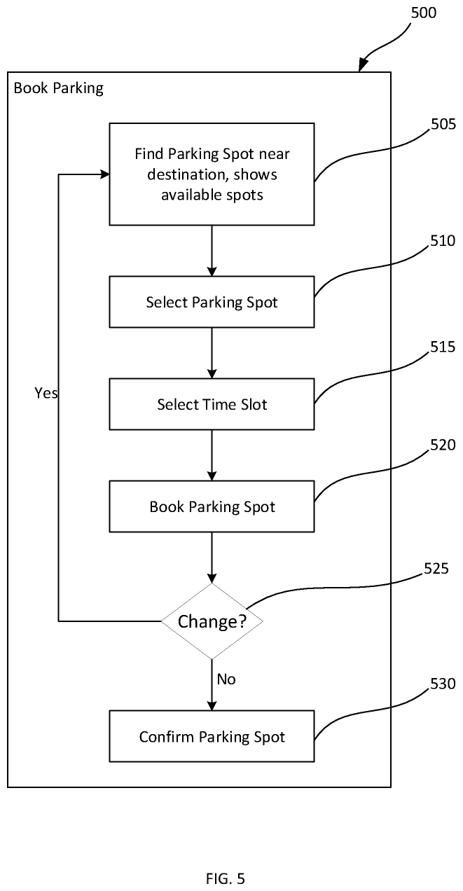

Referring to FIG. 5, a flow diagram of an embodiment of the operational steps of booking a parking spot 500 of the present invention is illustrated. A parking spot is found near a desired location and the available parking spots are provided to the requesting user 500. The user selects the desired parking spot 510 and selects the desired timeslot 515. Parking spot is then booked 520 by reserving the parking spot so that no other reservations can be made for the selected timeslot or by other users. During the booking process, payment for the parking spot can be may utilizing block chain and crypto currency payments. Prior to the confirmation of the parking spot, a determination may be made as to whether there has been a change 525 in the parking spot availability and/or the selection by the user. If a change has occurred, the process returns to the beginning 505 to allow the user to find an additional parking spot. If there has not been a change in the criteria for the parking spot, confirmation 530 for the parking spot will be provided to the user and parking facility.

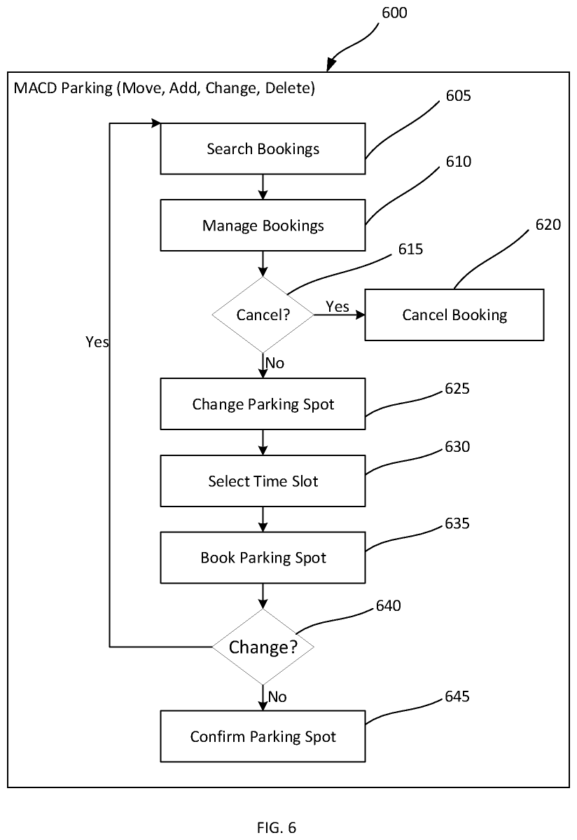

Referring to FIG. 6, a flow diagram of an embodiment of the modification of a parking spot booking 600 is illustrated. In this embodiment, a user may search various parking bookings at block 605 and manage those bookings 610. The management of the bookings can include reviewing the bookings for appropriate time and location criteria along with cost and other criteria by the user. If upon the management of the bookings it is determined that the criteria for the parking slot associated with that booking has changed, a determination 615 as to whether to cancel the booking will be undertaken. If the decision is to cancel the booking, the booking will be cancelled 620. In the event the booking should not be cancelled, the parking spot information may be updated 620, along with selection of a new time slots 630. The associated booking of the new parking spot will be updated 635. Prior to the confirmation of the updated parking spot, a determination 640 may be made as to whether there has been any additional changes in the parking spot availability and/or the selection by the user. If a change has occurred, the process returns to the beginning 605 to allow the user to find an additional parking spot. If there has not been a change in the criteria for the parking spot, confirmation 645 for the parking spot will be provided to the user and parking facility.

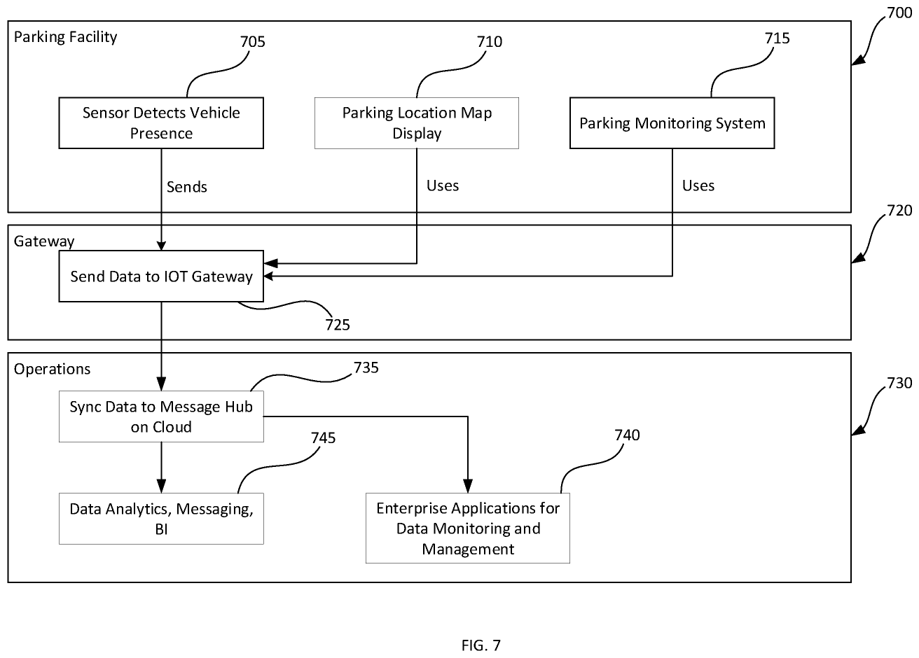

Referring now to FIG. 7, a schematic block diagram of the operational steps of an embodiment of the invention the present invention is illustrated. In this embodiment, a parking facility 700 utilizes sensors to detect the presence of vehicles in the parking slots in the facility 705. This information is provided to a gateway network 720 where the data is sent to an IOT gateway 725. Within the parking facility, a parking location map display 710 and a parking monitoring system 715 may also utilized and which may assist in the location of parking slots and the monitoring of the availability of the various parking slots. The related data is also provided to the through the IOT gateway for use by the parking system of the present invention and the users of the present invention.

The operational controls 730 of an embodiment of the system of the present invention receives the data from the parking facilities through the IOT gateway and syncs such data to a message hub on the cloud computer network data at 735. The data may then be analyzed 745 and may also be available for enterprise applications used by the user and the parking facilities for data monitor monitoring and management 740.

In this embodiment, the use of a gateway and/or an Internet of things gateway along with the cloud, and other aspects of the communications networks are merely illustrative and not meant to be limiting. Various other communication systems may be utilized and are within the scope of the present invention.

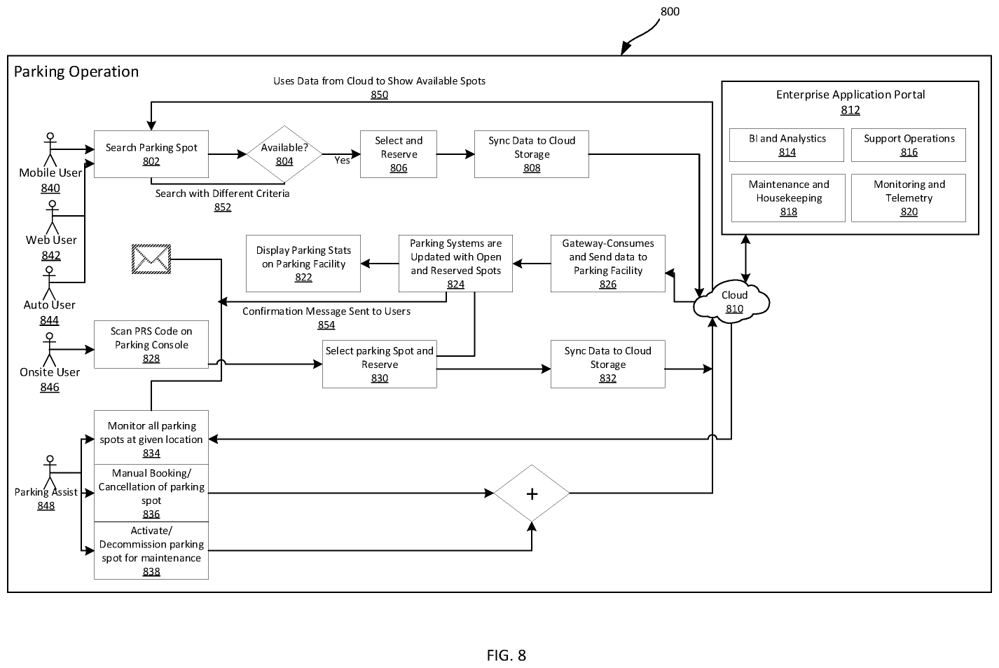

Referring now to FIG. 8, an embodiment of the operational steps of the parking operations 800 of the present invention is illustrated. In this embodiment, various users, such as a mobile user 840 a web user. 842 and/or an automobile, user 844 begins a search for a parking spot utilizing various criteria such as time, location and cost 802. The data relating to the searching of available parking spots is provided from a cloud network 810.

A determination is made as to whether there are one or more available parking spots that meet the user's search criteria. If no such parking spot is available with the established criteria, a new search is may be performed utilizing different criteria 852. If one or more slots parking spots are available, met with the established criteria, the user may select and reserve the parking spot 806. The data relating to the searching, selecting and reserving of the parking spot is provided 808 to the cloud network 810.

Cloud network 810 is in communication with an enterprise application portal 812 that includes various modules for operational and support applications, including an analytics module 814, support operations module 816, a maintenance and housekeeping module 818, and a monitoring and telemetry module 820. These modules provide instruction for communication and analysis of the various parking spot, availability, data, and the various parking spot request requests.

The selection of a parking spot may also be accomplished by a person who is on site at a specific parking facility, referred to as an on-site user 846. The on-site user 846 may begin a parking spot request by scanning a code into a parking console located at the facility 828. The on-site user 846 then selects a parking spot and reserves such spot 830. The reservation data is then sent to cloud storage 832.

A parking assistant 848 monitors and manages the availability of the parking spots at a given parking facility. The monitoring and management may include the manual booking and cancellations of parking reservations 838 and the monitoring of active and the decommission parking spots that have been closed for maintenance purposes 838. This information is provided to the cloud network 810.

The monitoring of all the parking spots at a given parking facility is monitored by the parking assistant 848 along with the parking server through the cloud system 810.

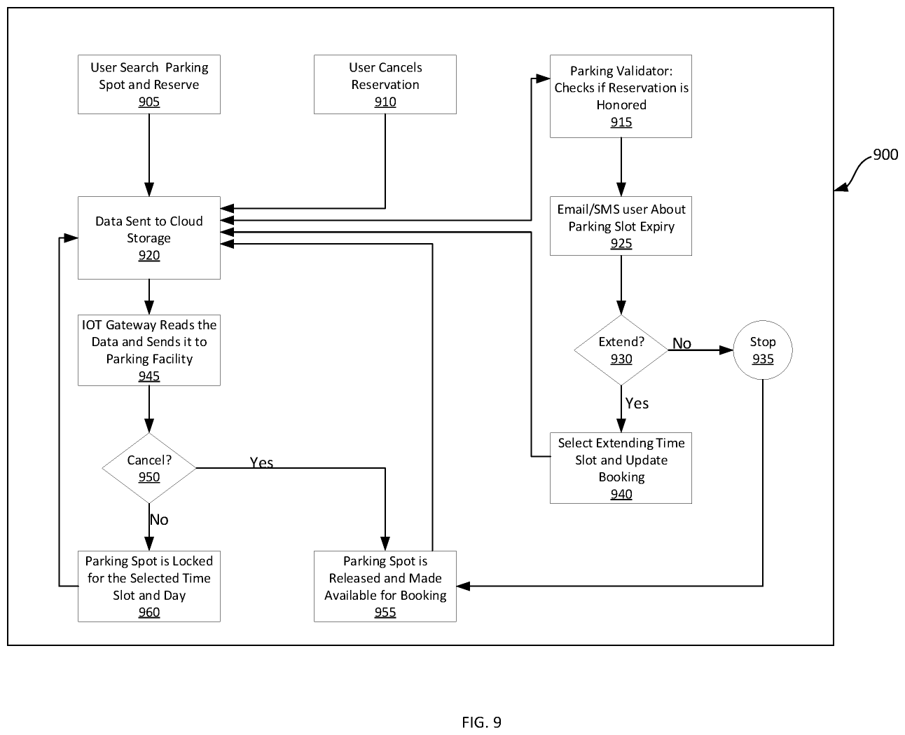

Referring now to FIG. 9, a schematic flow chart describing the operational steps taken by an embodiment of the present invention when a user fails to appear and park in a reserved parking spot at a given reserved time is illustrated. In this embodiment, a user searches and reserves a parking spot 905 and then either cancels or misses the reservation at 910. The search and reservation information along with the missing of the reservation data is provided to a parking locator and reservation system server, such as discussed above, through a cloud system 920.

A parking validation inquiry 915 may then be undertaken to determine if a reservation is to be honoured. This validation may include sending email and/or text messages to the user regarding the parking spot expiry 925. The inquiry may also include a determination as to whether to extend the parking spot reservation 930. If it is determined to not extend the reservation, the process is stopped and the parking spot is released and made available for new bookings 955.

If the reservation for the parking spot is to be extended, the parking reservation system will update the booking information 940 and provide the updated information to the parking facility 945. A determination may also be made at this time to cancel the reservation 950. If the reservation is cancelled. The parking spot will become released and made available for new bookings 955. If the parking spot is not to be reservation is not to be cancelled for the updated booking information. The spot parking spot is reserved for the selected updated time and date 960 with the information being provided back to the cloud storage 920 for further processing.

The exact specifications, materials used, and method of use of the parking locator and reservation system may vary upon manufacturing.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment(s) were chosen and described in order to best explain the principles of the present invention and its practical application, to thereby enable others skilled in the art to best utilize the present invention and various embodiments with various modifications as are suited to the particular use contemplated.

What is claimed is:

1) A parking locator and reservation system to provide parking location and reservations, the system comprising:
a parking facility module configured to receive and store parking facility data;
a user module configured to receive and store user data;
a billing module configured to process block chain and crypto currency payments;
a parking locator and reservation server configured to
receive a parking spot request from a user, the parking spot request having parking spot request data,
receive parking spot availability data from a parking facility,
identify at least one available parking spots based on the user data, parking facility data, parking spot request data and parking spot availability data, and
process payment from a user to a parking facility utilizing the billing module; and
a communication network interface configured to
receive the parking spot request from the user,
receive the parking spot availability data from the parking facility,
provide the available parking spots to the user,
receive a parking spot selection from the user,
book the selected parking spot, and
provide the user and parking facility of the booked parking spot.

2. The system of claim 1, wherein the parking facility data includes the parking facility's name, address, total number of available parking spots, and associated costs for parking.

3. The system of claim 1, wherein the user data 324 includes the user's name, address and price preferences.

4. A method for matching a locating and reserving a parking spot, the method comprising:
receiving a parking spot request from a user, the parking spot request having parking spot criteria;
receiving parking spot availability data from at least one parking facility;
determining available parking spots based on the parking spot criteria and parking spot availability data;
providing the available parking spots to the user;
receiving a selected parking spot from the provided available parking spots from the user;
booking the selected parking spot, the booking including processing payment for the selected parking spot; and
providing confirmation of the booking of the selected parking spot to the user and the parking facility.

5. A method of claim 4, wherein the payment for the selected parking spot utilizes a block chain payment system.

6. A method of claim 4, wherein the payment for the selected parking spot utilizes a crypto currency payment system.
